(19) United States
(12) Patent Application Publication
(10) Pub. No.: US 2010/0301087 A1
(43) Pub. Date: Dec. 2, 2010

(54) INTERPOSITION ANTI-CONTAMINATION TAPE DISPENSER

(76) Inventor: CHI-TSAI CHANG, Taichung City (TW)

Correspondence Address: LEONG C. LEI, PMB # 1008, 1839 YGNACIO VALLEY ROAD, WALNUT CREEK, CA, 94598, US

(21) Appl. No.: 12/691,719

(22) Filed: Jan. 21, 2010

(30) Foreign Application Priority Data
May 27, 2009 (TW) 098209501

(51) Int. Cl. B26F 3/02

(52) U.S. Cl. 225/91

(57) ABSTRACT

Disclosed is an interposition anti-contamination tape dispenser that includes two side panels forming axle portions that are oppositely fit to each other to interpose a middle ring between the side panels to form an interposition dispenser body. The middle ring forms a cutting opening to which a lift-to-open cutting blade is pivotally mounted so as to completely enclose an adhesive tape inside the dispenser and allow withdrawal of the tape through the cutting opening. With the interposed arrangement of the three parts, the structure of the tape dispenser shows a sandwiched construction, which allows for various combination of parts made of plastics of various colors so that the tape dispenser offers an efficacy of completely enclosed safe and sanitary arrangement and also provides flexible combination of various visual aesthetics.

### (a) TECHNICAL FIELD OF THE INVENTION

The present invention generally relates to an interposition anti-contamination tape dispenser having a body that is formed by two side panels and a middle ring that fit to each other to form a complete dispenser structure, wherein the middle ring has a circumferential surface that forms a recessed cutting opening having an end to which a cover like cutting blade is pivotally connected for being lifted open for cutting tape and pushed down to close and enclose the tape and the side panels have inside surfaces that form axle portions that are oppositely fit to each other to securely interpose the middle ring between the side panels with the adhesive tape being fit on the axle to be rotated in a controlled manner, whereby the whole dispenser uses the arrangement of interposing the middle ring to allow for color selection and parts replacement and also offers safe and sanitary operation in a completely enclosed arrangement.

### (b) DESCRIPTION OF THE PRIOR ART

A conventional portable tape dispenser has a primitive exposing design, as shown in FIG. 5 of the attached drawings, which comprises a dispenser body 30 that is formed by folding two thin side panels 31 that are integrally connected by a middle plate 32 to form a U-shaped outside configuration. An end of the plate 32 integrally forms a serrated cutting blade 33. Central portions of the two side panels 31, which are set opposite to each other, are raised inwards to form mated halves of expanded and contracted jointing means that are combined to provide an axle 34, which serves as a rotation axis over which a roll of adhesive tape 35 is rotatably fit. A leading end of the adhesive tape 35, after being withdrawn from the roll, can be cut off by the cutting blade 33. In this arrangement, the whole circumference of the dispenser is of an open and exposing design. This may cause concerns about contamination and safety, especially for the cutting blade 33 that is used to cut off the adhesive tape being exposed outside showing an open condition, which does not meet the needs of safety and sanitary requirement. This is particularly true for medical uses, which have more concerns about sanitary issues. To cope with the needs of practical applications in respect of sanitation and safety, enclosed tape dispenser is available in the market, and the present inventor also developed a number of tape dispensers in the form of enclosed box. However, those known enclosed structures of tape dispenser are manufactured in consideration of easy portability. Marks must be additionally provided on the tape dispensers for multiple users or simply for distinguishing between different users, otherwise identification would be very difficult. It is also hard to set different colors on the tape dispensers or make colorful combinations of parts according to personal preference. Thus, it is desired to provide a portable tape dispenser that allows for color-based identification/use and easy combination of various colors for beautifying an outside appearance thereof in order to suit the needs of diversified applications.

### SUMMARY OF THE INVENTION

In view of the simple-structured tape dispenser of the state of the art that does not satisfy the needs for aesthetics and assembling convenience neither the requirements of safety and sanitation, the present invention is made to provide an interposition anti-contamination tape dispenser, which comprises two opposite side panels that are fit to each other to interpose therebetween a middle ring to simultaneously set an adhesive tape therein and position the middle ring that enclose outside the adhesive tape whereby the adhesive tape is withdrawn through a cutting opening defined in the middle ring. With the interposed arrangement of the middle ring, the tape dispenser offers a completely enclosed and safe and sanitary construction and also allows the middle ring to be made of plastics of different colors to exhibit visual aesthetic features of colorful combination and assembling thereby overcoming the drawbacks of being monotonic and un-sanitary of the conventional tape dispensers.

The primary objective of the present invention is to form a structure of tape dispenser of a sandwiched interposition arrangement by using two side panels to interpose a middle ring and with color selection and selective combination of the two side panels and the middle ring, the outside appearance of the tape dispenser offers a completely enclosed, safe and sanitary feature and also provides the advantages of flexible changeability for aesthetic purposes.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a tape dispenser in accordance with the present invention.

FIG. 2 is a perspective view showing the tape dispenser of the present invention.

FIG. 3 is also a perspective view of the tape dispenser of the present invention showing a cutting blade in an operation condition.

FIG. 4 is an exploded view showing a tape dispenser in accordance with another embodiment of the present invention.

FIG. 5 is a perspective view showing a conventional hand-held portable tape dispenser.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

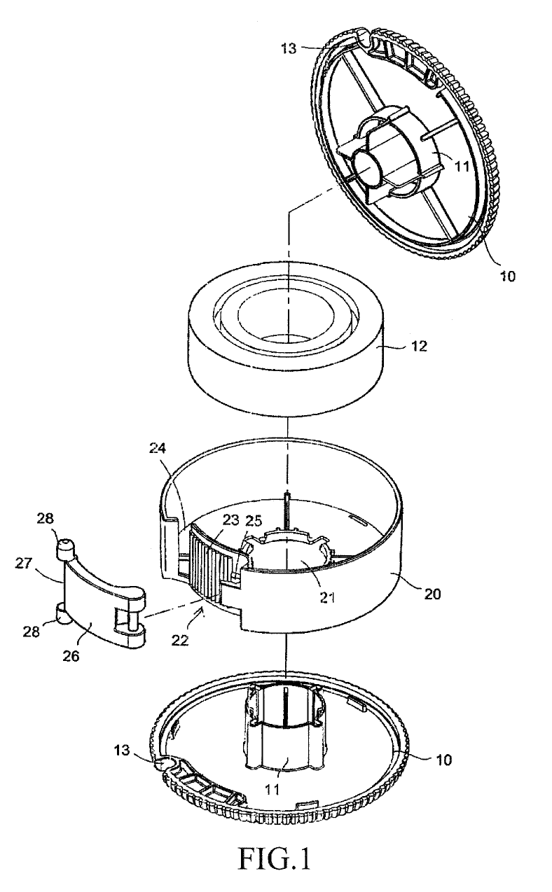

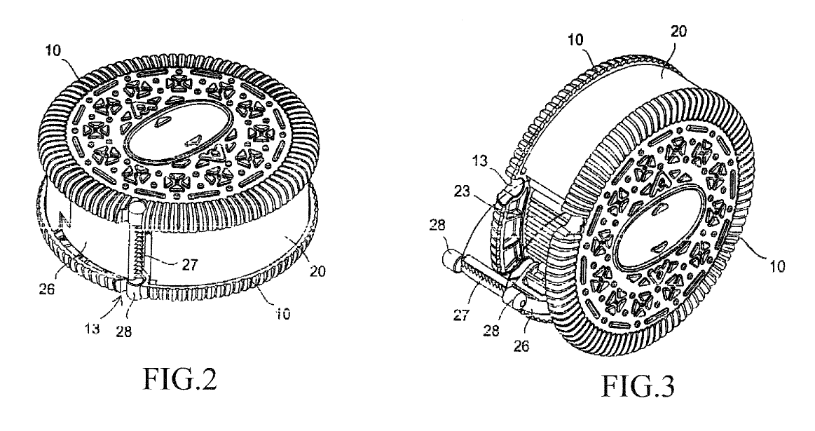

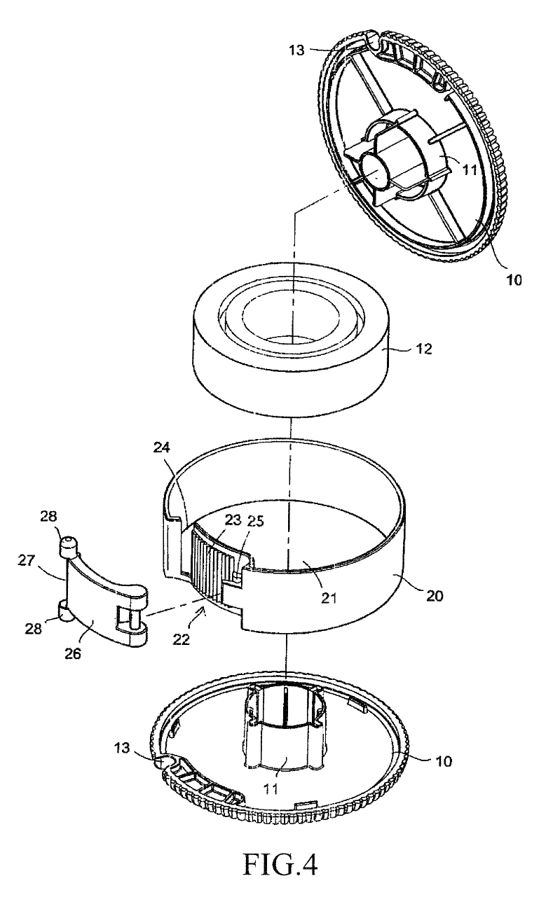

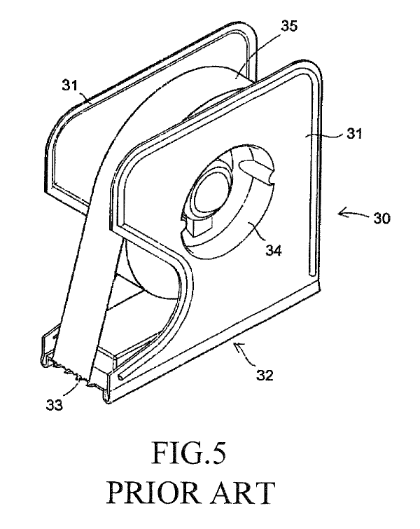

The present invention provides an interposition anti-contamination tape dispenser, which has a structure similar to a conventional stacked sandwiched structure. As shown in FIGS. 1-4, the tape dispenser of the present invention comprises two opposite shaped side panels 10, which are fit to and joint with each other for assembling. Each side panel 10 selectively forms unique raised and recessed patterns on an outside surface thereof for decorative and aesthetic purposes, or alternatively, the side panel may be made with a unique shape. Central portions of inside surfaces of the two side panels 10 are raised inward by a suitable height and having opposite ends forming expanded/contracted portions that mate and joint to each other to form an axle 11. The assembled axle 11 serves as a rotational shaft for receiving a roll of adhesive tape 12 rotatably fit thereon. The arrangement of the axle 11 can be composed of a plurality of axles according to the size of the side panels, provided the arrangement does not interfere with the mounting and rotation of the adhesive tape 12. Before the two side panels 10 are assembled and joint to each other, besides first setting the roll of adhesive tape 12, a middle ring 20, which serves as a middle interposed section, must be set between the two side panels to mate the two side panels for interposing and positioning. The structure of the middle ring 20 can be of a U-shaped cross-section as shown in FIG. 1, or of a ring tube configuration as shown in FIG. 4. Taking the U-shape as an example, the U-shape has a bottom that forms a through hole 21 in a central location thereof to correspond in shape and size to an outer shaped circumference of the axle 11 for mounting and positioning the middle ring 20 so that the middle ring 20 may not be displaced or rotated after the middle ring 20 is mounted. The middle ring 20 has a circumferential surface in which a slightly recessed cutting opening 22 is formed. An extension plate 23 of a suitable length is provided to form a bottom of the cutting opening 22 and the plate forms on a roughened surface thereon. An end of the plate is spaced from the middle ring 20 to define a withdrawn slot 24 for the adhesive tape. An opposite end of the extension board 23 is connected to the middle ring 20 and forms a recessed pivotal joint slot 25 to which a cutting blade 26 having an outside contour having a curved configuration corresponding to that of the middle ring 20 is fit and pivotally connected, whereby an end of the cutting blade 26 is directly and pivotally receivable in the pivotal joint slot 25 to allow the cutting blade 26 to be lifted for opening or pushed down for closing. To facilitate opening and closing the cutting blade 26, the cutting blade 26 is provided, on opposite sides of a movable end thereof, with operating and controlling pegs 28, and the side panels 10 form recessed engagement notches 13 at opposite locations corresponding to the withdrawal slot 24 of the middle ring 20, for the purposes of easy closing and securing of the cutting blade 26 after uses, whereby a cutting edge 27 that is formed, in a slightly recessed manner, in the end of the cutting blade 26 can be safety received inside an inner circumference of the cutting opening 22 in a condition showing the same curvature as the middle ring 20 without any portion projecting beyond and exposed outside the middle ring 22 to unexpectedly hurt a user and thus realizing true safety of use and storage. As such, the tape dispenser offers a practical feature that meets the needs for safety and changeable combination.

In the tape dispenser of the present invention, the structure of the tape dispenser is formed by two side panels 10 that interpose a middle ring 20 to form a fit and assembled arrangement, which, as a whole, shows an interposed configuration resembling to a sandwich. The side panels 10 and the middle ring 20 can be shaped separately and individually so that the side panels 10 may form, on a surface thereof, three-dimensional or embossed decorative patterns for beautification and may allow for interchange among various different shapes. The middle ring 20 and the parts thereof, such as the cutting blade 26, are changeable according to color design and patterned decoration so as to realize various combinations of shapes and colors and allow the tape dispenser to be changed by a user through easy assembling/disassembling and replacement of parts, making flexible and versatile change and combination of the outside configuration. This shows unique and novel visual perception when combined with color adhesive tapes 12 to thereby enhance changeability and flexibility of practical visual aesthetics, so that the tape dispenser offers not only a complete aesthetic configuration but also a safety solution for easily storing and concealing the cutting blade 26 that ensures safety of the tape as being enclosed and the convenience of use, cutting, and carrying. Such a structure, which is simple and offers changeability and flexibility of color, is not found in any of the known tape dispenser and such a novel structure that offers flexible change of parts and safety of assembling and use is a novel design of the tape dispenser.

To summarize, the interposition tape dispenser in accordance with the present invention provide a simple structure that is realized by two side panels interposing a middle ring and such a tape dispenser provides practical features of completely enclosing the tape contained therein for sanitary purposes and safe storage of the cutting blade. Particularly, the tape dispenser of the present invention allows for flexible change and combination of different colors of the middle ring so as to provide an aesthetic arrangement of the overall outside configuration of the tape dispenser that feature modern design of both vividness and beautifulness, as well as a safe construction for safe and sanitary use.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A tape dispenser comprising an assembled body made of plastics, the assembled body having a circumferential surface forming a recessed cutting opening outside which a cutting blade is arranged, so that an adhesive tape received inside the body is withdrawable through the cutting opening to be cut off for use, wherein the body of the dispenser is formed by jointing two side panels to each other, the side panels having opposite inside surfaces that are raised inward to form engageable portions that are jointed to each other to form an axle that receives the adhesive tape to rotatably fit thereon so as to serve as rotational axis of the adhesive tape, a middle ring being arranged between the two side panels and interposed between and positioned by the side panels, the middle ring having a circumferential surface forming the recessed cutting opening, a pivotal joint slot being formed at one end of the cutting opening to pivotally connecting the cutting blade to facilitate withdrawal and cutting of the adhesive tape, whereby a completely enclosed tape dispenser structure is formed by interposing the middle ring that carries the cutting blade between the two side panels.

2. The tape dispenser according to claim 1, wherein an extension plate is arranged at bottom of the cutting opening.

3. The tape dispenser according to claim 1, wherein the middle ring is structure to form a U-shaped cross-section or a ring tube configuration.

4. The tape dispenser according to claim 1, wherein the side panels, the middle ring, and the cutting blade are replaceable with different colors.

5. The tape dispenser according to claim 2, wherein the extension plate forms a roughened surface.

6. The tape dispenser according to claim 1, wherein the cutting opening of the middle ring forms a slot at an end of the extension plate for withdrawal and cutting of the adhesive tape.

7. The tape dispenser according to claim 1, wherein the cutting blade forms on opposite sides thereof projecting pegs that are engageable with notches that are recessed in the side panels for securing and positioning when the cutting blade is closed.

8. The tape dispenser according to claim 1, wherein the middle ring has a U-shaped cross-section, which has a bottom that defines a through hole corresponding in shape to an outer shaped circumference of the axle for mounting and positioning.

9. The tape dispenser according to claim 1, wherein the dispenser has an assembled structure resembling a sandwich.

10. The tape dispenser according to claim 1, wherein the side panels have outside surfaces that form three-dimensional or embossed patterns for decoration purposes.
